(19) United States
(12) Patent Application Publication
(10) Pub. No.: US 2014/0170618 A1
(43) Pub. Date: Jun. 19, 2014

(54) System and Method for Facilitating Career Growth in an Organization

(71) Applicant: BANK OF AMERICA CORPORATION, Charlotte, NC (US)

(72) Inventors: Madhu Bhimavarapu, Hyderabad (IN); Shallu Anand, New Delhi (IN); Nishant Kumar Saxena, Gurgaon (IN)

(73) Assignee: Bank of America Corporation, Charlotte, NC (US)

(21) Appl. No.: 13/720,156

(22) Filed: Dec. 19, 2012

(51) Int. Cl. G09B 19/00

(52) U.S. Cl. CPC G09B 19/00
USPC 434/219

(57) ABSTRACT

Assisting career growth in an organization comprises receiving a current skillset associated with an associate, wherein the current skillset comprises one or more current skills, and receiving an interested skill from a first computer associated with the employee. One or more intermediate skills between the current skillset and the interested skill, wherein an intermediate skill comprises the interested skill, is determined.

### TECHNICAL FIELD OF THE INVENTION

This invention relates generally to career growth in an organization, and more particularly to career growth in an organization through a career growth module.

### BACKGROUND OF THE INVENTION

Employees generally learn new skills when working in a position in an organization. While an employee may seek out particular positions to learn specific skills, sometimes employees do not have the opportunity to identify different positions to develop the additional skills.

### SUMMARY OF THE INVENTION

According to embodiments of the present disclosure, disadvantages and problems associated with developing capabilities within an organization may be reduced or eliminated.

In certain embodiments, assisting career growth in an organization comprises receiving a current skillset associated with an associate, wherein the current skillset comprises one or more current skills, and receiving an interested skill from a first computer associated with an associate. One or more intermediate skills between the current skillset and the interested skill, wherein an intermediate skill comprises the interested skill, is determined.

Certain embodiments of the present disclosure may provide one or more technical advantages. A technical advantage of one embodiment includes providing a career growth program based on an associate's current skillset and desired skill. Yet another technical advantage includes providing a current skillset structure and standardized approach to leverage employee development to positions within the company, thereby creating an environment to promote maturation and development of organizational capability and retention. By promoting associate development and maturation, an organization may further experience efficiency in other resources, such as computing resources. Yet another technical advantage of one embodiment includes providing a management framework to measure associate skillset development.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of an embodiment of a system for assisting personal career growth in an organization;

FIG. 2 illustrates a flowchart for assisting personal growth in the organization;

FIG. 3 illustrates an example record in a database that stores information regarding a current skillset associated with an associate;

FIG. 4 illustrates a screenshot listing various skill options associated with an associate's current skillset, an associate's interested skill, or a position skillset;

FIG. 5 illustrates a screenshot that illustrates a career plan regarding positions that match an associate's intermediate skills.

### DETAILED DESCRIPTION OF THE INVENTION

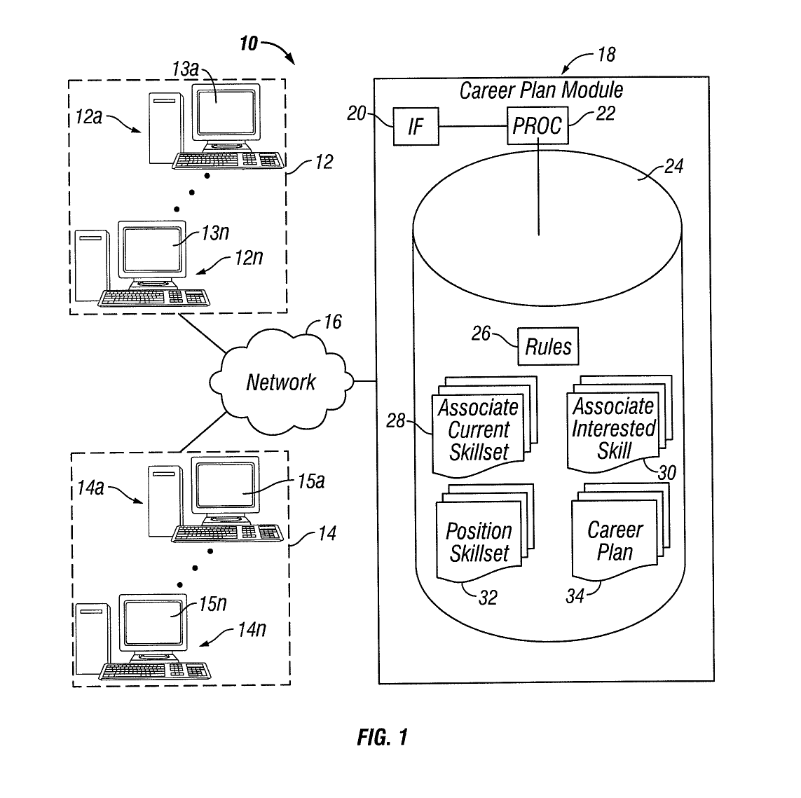

Embodiments of the present invention and its advantages are best understood by referring to FIGS. 1 through 5 of the drawings, like numerals being used for like and corresponding parts of the various drawings.

Associates work within an organization and perform various tasks in their positions. For example, an associate may be an accountant for an organization and develop certain skills in that position. However, an associate may want to develop a new skill. One way to develop a new skill is to obtain a new position that will teach that skill. It may be difficult for an associate to find a new position that not only will teach the new skill, but also is a position that the associate is qualified to obtain. In addition, an associate may find it difficult to know which positions are available within an organization and to ascertain which intermediate skills are necessary to develop the new skill.

Therefore, it is advantageous to provide a system and method to assist personal career growth in an organization through a career plan module. An associate inputs their current skillset and interested skill into a system. A manager inputs a position with its associated skills into a system. The system determines intermediate skills between the employee's current skillset and their interested skill, and determines if any available positions contains that intermediate skill. This improves the associate's efficiency to seek and ascertain a new position in the organization that develops their skillset, an organization's retention of its associates, and associate morale. This is particularly advantageous for large organizations that have several positions located across various business units.

FIG. 1 illustrates a block diagram of an embodiment of a system 10 for assisting personal growth within an organization. System 10 includes one or more associate computers 12 and one or more manager computers 14 that communicate over one or more networks 16 with career plan module 18 to facilitate assisting personal career growth in an organization. Associate computer 12 interacts with career plan module 18 to establish the associate's current skillset and interested skill. Career plan module 40 determines intermediate skills required by the associate to progress from the associate's current skillset to their interested skill. Manager computer 14 interacts with career plan module 18 to establish particular skills associated with a position in the organization. Career plan module 18 compares the position skills with the associate's intermediate skills to determine whether an intermediate skill matches a position skill. If an intermediate skill matches a position skill, career plan module 18 communicates the position to the respective associate computer 12a.

Using career plan module 18, an organization may provide a unified framework to capture an associate's current skillset, an associate's skill interest, and positions within an organization. Therefore, associates may continually enhance their capabilities within an organization, and the organization may benefit from having trained and developed associates. Having trained and developed associates improves the efficiency of an organization, may improve associate's morale, and reduces the replacement cost to an organization to replace an associate. Furthermore, computer resources and bandwidth may be conserved by improving the efficiency of the organization through its associates.

System 10 includes associate computers 12a-12n, where n represents any suitable number, that communicate with career plan module 18 through network 22. For example, associate computer 12 communicates with career plan module 18 to establish the associate's current skillset and interested skill. In the illustrated embodiment, associates within an organization use associate computer 12. Associates may represent any individual in an organization. Associate computer 12 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Associate computer 12 may also comprise a user interface, such as a display, keyboard, mouse, or other appropriate terminal equipment.

In the illustrated embodiment, associate computer 12 includes a graphical user interface (“GUI”) 13 that displays information received from career plan module 18. For example, GUI 13 may display career plan information to an associate using associate computer 12. GUI 13 is generally operable to tailor and filter data entered by and presented to the user. GUI 13 may provide the user with an efficient and user-friendly presentation of information using a plurality of displays having interactive fields, pull-down lists, and buttons operated by the user. GUI 13 may include multiple levels of abstraction including groupings and boundaries. It should be understood that the term GUI 13 may be used in the singular or in the plural to describe one or more GUIs 13 in each of the displays of a particular GUI 13.

System 10 also includes manager computers 14a-14n, where n represents any suitable number, that communicate with career plan module 18 through network 16. For example, manager computer 14 communicates with career plan module 18 to establish a skillset associated with a position in the organization. As another example, manager computer 14 communicates with career plan module 18 to receive information regarding associates that have an intermediate skill that matches a skill in a skillset associated with a particular position. In the illustrated embodiment, managers may represent any individual in an organization that has information regarding a position within an organization. Manager computer 14 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Manager computer 14 may also comprise a user interface, such as a display, keyboard, mouse, or other appropriate terminal equipment.

In the illustrated embodiment, manager computer 14 includes GUI 15 that displays information received from career plan module 18. For example, GUI 15 may display an associate skillset to a manager using manager computer 14. GUI 15 is generally operable to tailor and filter data entered by and presented to the user. GUI 15 may provide the user with an efficient and user-friendly presentation of information using a plurality of displays having interactive fields, pull-down lists, and buttons operated by the user. GUI 15 may include multiple levels of abstraction including groupings and boundaries. It should be understood that the term GUI 15 may be used in the singular or in the plural to describe one or more GUIs 15 in each of the displays of a particular GUI 15.

Network 16 represents any suitable network operable to facilitate communication between the components of system 10 such as associate computers 12, manager computers 14, and career plan module 18. Network 16 may include any interconnecting system capable of transmitting audio, video, signals, data, messages, or any combination of the preceding. Network 16 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Career plan module 18 represents any suitable component that facilitates the management and integration of an associate's skillset and interested skill, a position skillset, and a career plan. Career plan module 18 analyzes an associate's skillset and interested skill to determine positions available to help progress an associate towards their interested skill. Career plan module 18 may also create various reports based on the analysis and comparison of the skill levels and available positions.

Career plan module 18 may include a network server, any suitable remote server, a mainframe, a host computer, a workstation, a web server, a personal computer, a file server, or any other suitable device operable to communicate with associate computers 12 and/or manager computers 14. In some embodiments, career plan module 18 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of career plan module 18 may be performed by any suitable combination of one or more servers or other components at one or more locations. In the embodiment where career plan module 18 is a server, the server may be a private server, or the server may be a virtual or physical server. The server may include one or more servers at the same or remote locations. Also, career plan module 18 may include any suitable component that functions as a server. In the illustrated embodiment, career plan module 18 includes a network interface 20, a processor 22, and a memory 24.

Network interface 20 represents any suitable device operable to receive information from network 16, transmit information through network 16, perform processing of information, communicate with other devices, or any combination of the preceding. For example, network interface 20 receives a request from associate computer 12 to modify associate current skillset 28 and associate interested skill 30. Network interface 20 represents any port or connection, real or virtual, including any suitable hardware and/or software, including protocol conversion and data processing capabilities, to communicate through a local area network (LAN), wide area network (WAN), or other communication system that allows career plan module 18 to exchange information with network 16, associate computers 12, manager computers 14, or other components of system 10.

Processor 22 communicatively couples to network interface 20 and memory 24, and controls the operation and administration of career plan module 18 by processing information received from network interface 20 and memory 24. Processor 22 includes any hardware and/or software that operates to control and process information. For example, processor 22 executes rules 26 to control the operation of career plan module 18. Processor 22 may be a programmable logic device, a microcontroller, a microprocessor, any suitable processing device, or any suitable combination of the preceding.

Memory 24 stores, either permanently or temporarily, data, operational software, or other information for processor 22. Memory 24 includes any one or a combination of volatile or non-volatile local or remote devices suitable for storing information. For example, memory 24 may include random access memory (RAM), read only memory (ROM), magnetic storage devices, optical storage devices, or any other suitable information storage device or a combination of these devices. In the illustrated embodiment, memory 24 includes rules 26, associate current skillset 28, associate interested skill 30, position skillset 32, and career plan 34.

Rules 26 generally refer to logic, rules, algorithms, code, tables, and/or other suitable instructions embodied in a computer-readable storage medium for performing the described functions and operations of career plan module 18. For example, rules 26 facilitate the determination of a career plan for an associate to obtain their interested skill. In an embodiment, the career plan determination may be made based on the associate's current skillset and the associate's interested skill. As another example, rules 26 facilitate the identification of opportunities in the organization for an associate based on an associate's career plan. To identify these other opportunities, rules 26 may reference the intermediate skills necessary to obtain the associate's interested skill. While illustrated as including a particular module, memory 24 may include any suitable information for use in the operation of career plan module 18.

Associate current skillset 28 generally refers to the various skills associated with an associate in an organization. Associate computer 12 communicates skills to career plan module 18, and career plan module 18 stores associate current skillset 28 to use in determining a career path for an associate. Associate current skillset 28 may vary depending on the position within the organization, work history, and other learned skills. For example, associate current skillset 28 for an associate in the technology business unit may include application development, product support, project management, testing, architecture, and infrastructure. In addition, the associate current skillset 28 may also include skills acquired by the associate in past positions. For example, for an associate that previously worked in the technology unit, the associate current skillset 28 may also include programming languages, hardware support, software support, and technical support. Associate current skillset 28 may also refer to sub-skills of each skill. As an example, the testing skill area may have sub-skills, such as certifications, test design, test execution, test management, and test planning and strategy. Associate computer 12 may also communicate the sub-skills to career plan module 18, and career plan module 18 stores the information in memory 24.

Associate interested skill 30 generally refers to a skill an associate wishes to learn or obtain. Associate computer 12 communicates interested skill to career plan module 18, and career plan module 18 stores associate interested skill 30 to use in determining a career path for an associate. For example, for an associate that is interested in obtaining a management role, associate computer 12 may communicate people management as interested skill 30. Associate interested skill 30 may also refer to sub-skills of a skill. This may include certifications, test design, test execution, test management, and test planning and strategy.

Position skillset 32 generally refers to the various skills associated with a position in the organization. Manager computer 14 communicates skills to career plan module 18, and career plan module 18 stores position skillset 32 to use in determining a position for an associate within the organization. Position skillset 32 may vary depending on the position within the organization. For example, for an associate in the technology business unit, the position skillset 44 may include application development, product support, project management, testing, architecture, and infrastructure. Position skillset 32 may also refer to sub-skills of each skill. As an example, the testing skill area may have sub-skills, such as certifications, test design, test execution, test management, and test planning and strategy. Manager computer 14 may also communicate the sub-skills to career plan module 18, and career plan module 18 stores the information in memory 24.

Career plan 34 refers to a set of intermediate skills required to achieve the associate's interested skill and one or more positions comprising those intermediate skills. The set represents a career map available to an associate to ascertain their interested skill. Career plan module 18 determines career plan 34 from associate current skillset 28 and associate interested skill 30, and stores career plan 34 in memory 24. For example, for a software engineer that currently knows C++ Level 1 and would like to learn Java Level 2, career plan 34 may include a position containing the skill Java Level 1 and a position containing the skill Java Level 2. Career plan module 18 may retrieve career plan 34 to communicate to associate computer 12.

In an exemplary embodiment of operation, career plan module 18 receives a current skillset and an interested skill associated with an associate from associate computer 12. Career plan module 18 determines intermediate skills required to develop an interested skill from the current skillset. Generally, intermediate skills are skills necessary to develop an interested skill from the associate's current skillset. Career plan module 18 also receives a position skillset associated with a position from manager computer 14.

Career plan module 18 compares the intermediate skills with the skills in the position skillset. If the intermediate skill matches a skill in a position skillset, career plan module 18 communicates the position to associate computer 12.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of associate computers 12, manager computers 14, networks 16, and career plan modules 18. Any suitable logic may perform the functions of system 10 and the components within system 10.

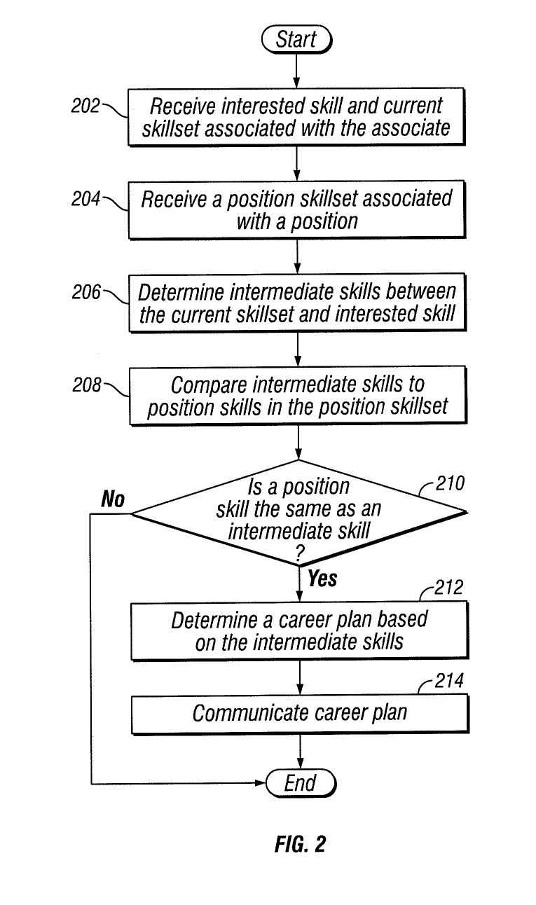

FIG. 2 illustrates a flowchart for assisting personal growth in an organization. At step 202, career plan module 18 receives an interested skill and a current skillset associated with an associate. In an embodiment, an associate enters this information into associate computer 12, and associate computer 12 communicates the skill and skillset to career plan module 18. Career plan module 18 may also receive parameters indicating an associate's current position, identification information, whether the associate is interested in obtaining a new position, or whether the associate would like to remain private or anonymous. Career plan module 18 may also determine an associate's length at current position, associate's location, and/or associate's geographical preference.

The associate current skillset may include various skills associated with associate's current position, associate's past position, or expertise. For example, skills may include application development, product support, project management, testing, architecture, or infrastructure. Within each skill area, there may be associated sub-skills as defined by the organization and/or the associate. For example, within the application development skill set, sub-skills may include: code construction, reviews, testing; communication; process governance; requirements management, solution design, and architecture; and tools and platform usage. Within the product support skill set, sub-skills may include: analytical skills, application architecture, application knowledge, documentation/reporting skills, problem triage skills, and technical knowledge. Within the project management skill set, sub-skills may include application knowledge, certifications, general management skills, and project management knowledge. Within the testing skill set, sub-skills may include certifications, test design, test execution, test management, and test planning and strategy. Each position may have any number of associated skills and sub-skills as defined by the associate and/or the organization. By evaluating across a broad range of skill areas, career plan module 18 facilitates multi-dimensional position recommendations.

The interested skill may include various skills that an associate is interested in obtaining. These skills may range from Java development to conflict management and levels associated with each respective skill. The interested skill may also include sub-skills. In a preferred embodiment, the selectable interested skills will be of the same subset of skills available for selection in the applicant current skillset and position skillset.

At step 204, career plan module 18 receives a position skillset associated with a position. In an embodiment, a manager enters this information into manager computer 14, and manager computer 14 communicates the position skillset to career plan module 18. Career plan module 18 may also receive parameters indicating the location of the position, the training length required with the position, required skills needed for the position, whether the position has availability, whether the manager would not like to disclose position, and/or whether an associate may contact the manager.

The position skillset may include various skills associated with a position. For example, skills may include application development, product support, project management, testing, architecture, or infrastructure. Within each skill area, there may be associated sub-skills as defined by the organization and/or the associate. For example, within the application development skill set, sub-skills may include: code construction, reviews, testing; communication; process governance; requirements management, solution design, and architecture; and tools and platform usage. Within the product support skill set, sub-skills may include: analytical skills, application architecture, application knowledge, documentation/reporting skills, problem triage skills, and technical knowledge. Within the project management skill set, sub-skills may include application knowledge, certifications, general management skills, and project management knowledge. Within the testing skill set, sub-skills may include certifications, test design, test execution, test management, and test planning and strategy. Each position may have any number of associated skills and sub-skills as defined by the associate and/or the organization.

At step 206, career plan module 18 determines intermediate skills between the associate current skillset and interested skill. For example, career plan module 18 may determine a mapping of positions based on a hierarchy of positional skills. For example, Conflict Resolution—Level 3 will also require Conflict Resolution—Level 2 and Conflict Resolution—Level 1. This hierarchy may become more complex when more skills and cross-skills are added to requirements for a positional skill. For example, Java Development—Level 3 may require Java Development—Level 2. In turn, Java Development—Level 2 may require Java Development—Level 1, Application Development—Level 1, Application Packaging, and Analytics and Quality Control Training. Career plan module 18 may then determine intermediate skills based on determining which skills are required for an associate to achieve an interested skill from the associate's current skillset. For example, if an associate is interested in Java Development—Level 3 and has a current skillset of Java Development—Level 1, Quality Control Training, and Analytics, career plan module 18 will determine that the intermediate skillset comprises Java Development—Level 3, Java Development—Level 2, and Application Packaging. The hierarchal skill mapping may also account for skills that are interchangeable. For example, Java—Level 2 may require either Java—Level 1 or C++—Level 1. In addition, the hierarchal skill mapping may account for any preferred skills. These specific hierarchal skill mapping may change based on the organization.

In certain embodiments, a manager may customize the intermediate skills. A manager may create, add, remove, replace, or change intermediate skills associated with a particular associate. A manager may also create, add, remove, replace, or change an intermediate skill with one or more training programs.

At step 208, career plan module 18 compares the intermediate skills to position skills in the position skillset. If the position skill is the same as an intermediate skill, career plan module 18 determines a career plan for the associate at step 212. In an embodiment, career plan module 40 also receives information regarding training programs available to ascertain interested skills and includes those training programs in the career plan. In another embodiment, a manager may add, remove, replace, or change the career plan associated with an associate. At step 214, career plan module 40 communicates the career plan to associate computer 12 and/or manager computer 14. With the career plan, career plan module 18 may provide information that facilitates the application by an associate to an available position within the organization or communication to the manager associated with the position.

Modifications, additions, or omissions may be made to the method depicted in FIG. 2. In an embodiment, career plan module 18 will automatically communicate a career plan to an associate after the associate's employment length becomes greater than a pre-determined period of time. Career plan module 18 may also communicate this information to manager computer 12. The method may include more, fewer, or other steps. Additionally, steps may be performed in parallel or in any suitable order. Any suitable component of system 10 may perform one or more steps of the method.

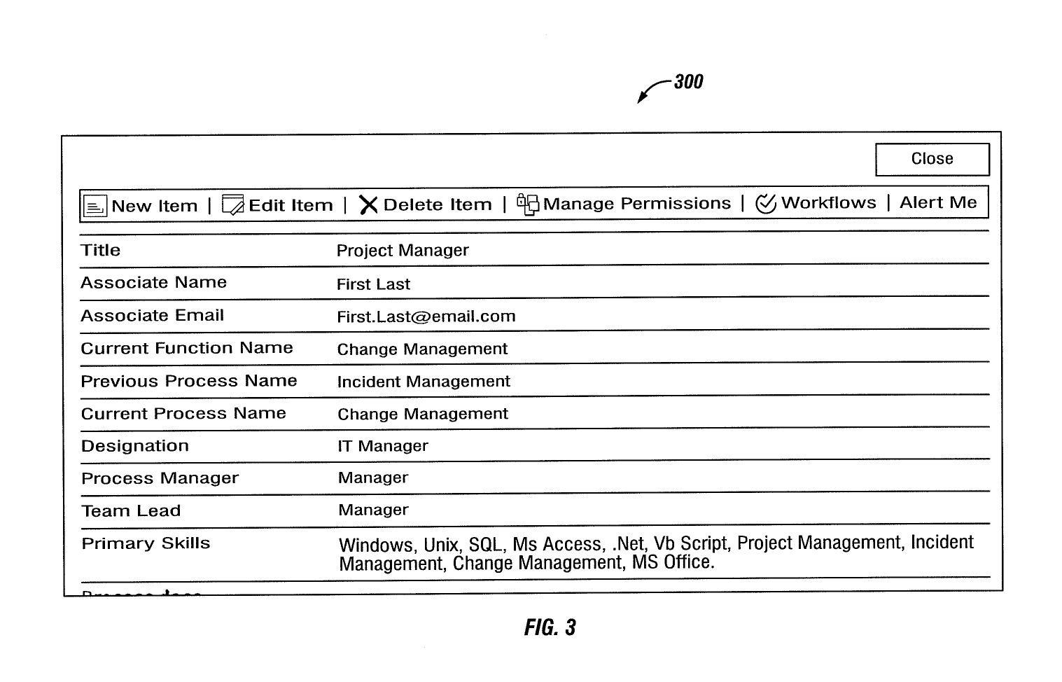

FIG. 3 illustrates an example record 300 in a database that stores information regarding a current skillset associated with an associate. As discussed above, associate computer 14 interacts with career plan module 18 to establish the associate's current skillset and interested skill. Record 300 includes information related to the associate, such as the associate name, associate e-mail, current job title, manager information, and current skillset. Modifications, additions, or omissions may be made to record 300 without departing from the scope of the invention.

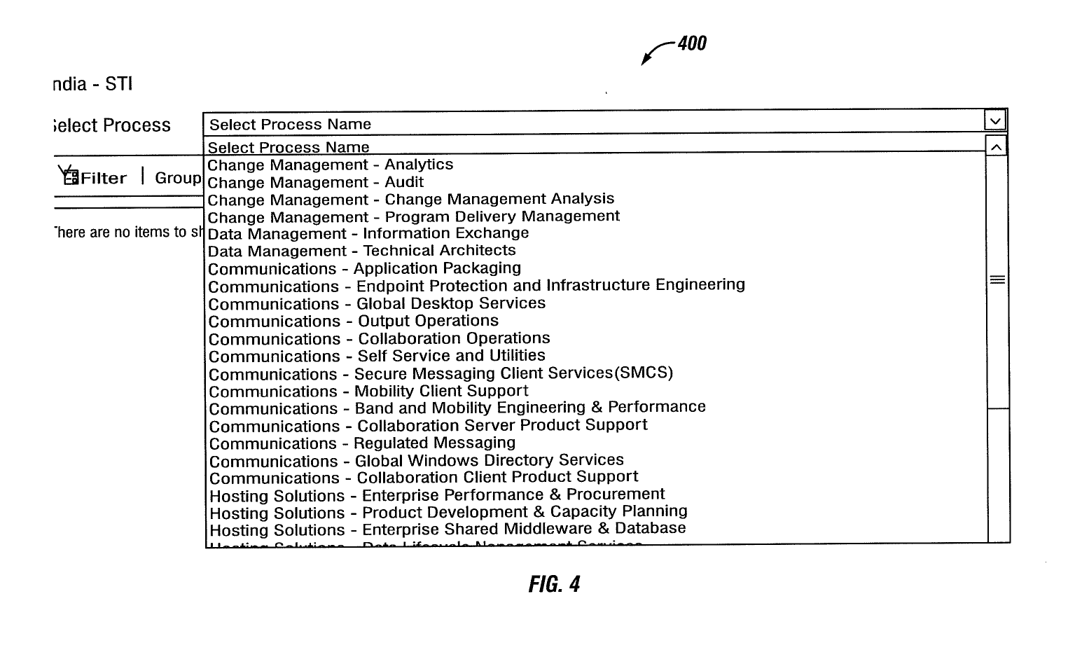

FIG. 4 illustrates a screenshot 400 listing various skill options associated with an associate's current skillset, an associate's interested skill, or a position skillset. As discussed above, screenshot 400 illustrates skills that career plan module 18 may receive from associate computer 12 or manager computer 14. Modifications, additions, or omissions may be made to screenshot 400 without departing from the scope of the invention.

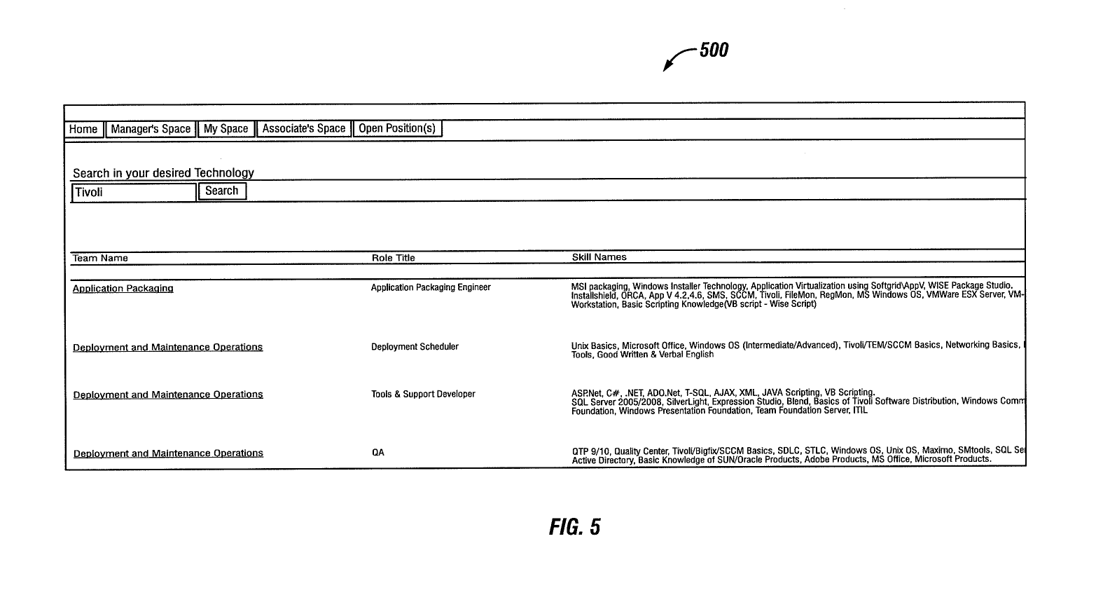

FIG. 5 illustrates a screenshot 500 that illustrates a career plan regarding positions that match an associate's intermediate skills. As discussed above, career plan module 18 determines career plan 34 from associate current skillset 28 and associate interested skill 30 and stores career plan 34 in memory 26. Screenshot 500 illustrates example positions in career plan 34 that career plan module 30 determines from associate current skillset 28, associate interested skill 30, and position skill 32. Modifications, additions, or omissions may be made to screenshot 500 without departing from the scope of the invention.

Certain embodiments of the present disclosure may provide one or more technical advantages. A technical advantage of one embodiment includes providing a career growth program based on an associate's current skillset and desired skill. Yet another technical advantage includes providing a current skillset structure and standardized approach to leverage employee development to positions within the company, thereby creating an environment to promote maturation and development of organizational capability and retention. By promoting associate development and maturation, an organization may further experience efficiency in other resources, such as computing resources. Yet another technical advantage of one embodiment includes providing a management framework to measure associate skillset development.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for assisting career growth in an organization, comprising
a network interface operable to:
receive a current skillset associated with an associate, wherein the current skillset comprises one or more current skills;
receive an interested skill from a first computer associated with the associate; and
a processor communicatively coupled to the network interface and operable to determine one or more intermediate skills between the current skillset and the interested skill, wherein an intermediate skill comprises the interested skill.

2. The system of claim 1, wherein:
the interface is further operable to receive a position skillset associated with a position from a second computer associated with a manager, wherein the position skillset comprises one or more position skills; and
the processor is further operable to compare the one or more intermediate skills to the one or more position skills to determine whether an intermediate skill matches a position skill.

3. The system of claim 2, wherein the interface is further operable to communicate the position to the first computer associated with the associate if an intermediate skill matches a position skill.

4. The system of claim 2, wherein:
the processor is further operable to:
determine a current position term associated with the employee;
compare the current position term to a maximum position term; and
the interface is further operable to communicate the position to the first computer associated with the associate if an intermediate skill matches a position skill and the current position term is greater than or equal to the maximum position term.

5. The system of claim 2, wherein:
the interface is further operable to:
receive a required skillset associated with the position from a second computer associated with a manager, wherein the required skillset comprises one or more required skills;
communicate the position to the first computer associated with the associate if a current skill matches required skill and if an intermediate skill matches a position skill; and
the processor is further operable to compare one or more current skills in the current skillset to one or more required skills in the required skillset.

6. The system of claim 1, wherein:
the interface is further operable to:
receive a plurality of position skills in a position skillset associated with a position;
communicate a career plan to the first computer associated with the associate;
the processor is further operable to:
compare the one or more intermediate skills to the one or more position skills; and
determine the career plan based on the intermediate skills, wherein the career plan comprises the intermediate skills and one or more positions comprising the intermediate skills.

7. A method for assisting career growth in an organization, comprising:
receiving a current skillset associated with an associate, wherein the current skillset comprises one or more current skills;
receiving an interested skill from a first computer associated with the associate; and
determining, by a processor, one or more intermediate skills between the current skillset and the interested skill, wherein an intermediate skill comprises the interested skill.

8. The method of claim 7, further comprising:
receiving a position skillset associated with a position from a second computer associated with a manager, wherein the position skillset comprises one or more position skills; and
comparing, by the processor, the one or more intermediate skills to the one or more position skills to determine whether an intermediate skill matches a position skill.

9. The method of claim 8, further comprising if an intermediate skill matches a position skill, communicating the position to the first computer associated with the associate.

10. The method of claim 8, further comprising:
determining, by the processor, a current position term associated with the employee;
comparing, by the processor, the current position term to a maximum position term; and
if an intermediate skill matches a position skill and the current position term is greater than or equal to the maximum position term, communicating the position to the first computer associated with the associate.

11. The method of claim 8, further comprising:
receiving a required skillset associated with the position from a second computer associated with a manager, wherein the required skillset comprises one or more required skills;
comparing, by the processor, one or more current skills in the current skillset to one or more required skills in the required skillset; and
if a current skill matches required skill and if an intermediate skill matches a position skill, communicating the position to the first computer associated with the associate.

12. The method of claim 7, further comprising:
receiving a plurality of position skills in a position skillset associated with a position;
comparing, by the processor, the one or more intermediate skills to the one or more position skills;
determining, by the processor, a career plan based on the intermediate skills, wherein the career plan comprises the intermediate skills and one or more positions comprising the intermediate skills; and
communicating the career plan to the first computer associated with the associate.

13. Non-transitory computer readable medium comprising logic, the logic, when executed by a processor, operable to:
receive a current skillset associated with an associate, wherein the current skillset comprises one or more current skills;
receive an interested skill from a first computer associated with the associate; and
determine one or more intermediate skills between the current skillset and the interested skill, wherein an intermediate skill comprises the interested skill.

14. The computer readable medium of claim 13, wherein the logic is further operable to:
receive a position skillset associated with a position from a second computer associated with a manager, wherein the position skillset comprises one or more position skills; and
compare the one or more intermediate skills to the one or more position skills to determine whether an intermediate skill matches a position skill.

15. The computer readable medium of claim 14, wherein the logic is further operable to communicate the position to the first computer associated with the associate if an intermediate skill matches a position skill.

16. The computer readable medium of claim 14, wherein the logic is further operable to:
determine a current position term associated with the employee;
compare the current position term to a maximum position term; and
if an intermediate skill matches a position skill and the current position term is greater than or equal to the maximum position term, communicate the position to the first computer associated with the associate.

17. The computer readable medium of claim 14, wherein the logic is further operable to:
receive a required skillset associated with the position from a second computer associated with a manager, wherein the required skillset comprises one or more required skills;
compare one or more current skills in the current skillset to one or more required skills in the required skillset; and
if a current skill matches required skill and if an intermediate skill matches a position skill, communicate the position to the first computer associated with the associate.

18. The computer readable medium of claim 13, wherein the logic is further operable to:
receive a plurality of position skills in a position skillset associated with a position;
compare the one or more intermediate skills to the one or more position skills;
determine a career plan based on the intermediate skills, wherein the career plan comprises the intermediate skills and one or more positions comprising the intermediate skills; and
communicate the career plan to the first computer associated with the associate.
